(19) United States
(12) Patent Application Publication
(10) Pub. No.: US 2004/0200013 A1
(43) Pub. Date: Oct. 14, 2004

(54) Method for manufacturing natural dye using beer sludge, natural dye manufactured by the method, dyeing method of fiber products using the natural dye, and fiber products dyed by the method

(76) Inventors: Jae-Gi Moon, Daegu (KR); Oh-Kyung Kwon, Daegu (KR); Bu-Hun Son, Daegu (KR); Young-Hee Choi, Daegu (KR)

Correspondence Address: JACOBSON HOLMAN PLLC, 400 SEVENTH STREET N.W., SUITE 600, WASHINGTON, DC, 20004, US

(21) Appl. No.: 10/802,795

(22) Filed: Mar. 18, 2004

(30) Foreign Application Priority Data
Apr. 11, 2003 (KR) 10-2003-22996

(51) Int. Cl. C09B 61/00

(52) U.S. Cl. 8/438

(57) ABSTRACT

The present invention relates to a method for manufacturing a natural dye using beer sludge, and a dyeing method of a fiber product using a natural dye fabricated by the above method capable of extracting natural components from beer sludge that is a by-product after beer is manufactured. The method includes the steps of a step for drying beer sludge, a step for mixing the dried beer sludge with a certain extraction solvent selected from the group comprising water, electrolysis reduction water, and electrolysis oxidation water, and extracting a coloring component, and a step for filtering an extraction liquid. It is possible to achieve a desired recycling effect using wastes of beer sludge. The woven fabrics dyed using the dyes extracted from beer sludge may be widely adapted to various fiber products and has an excellent laundry fastness and excellent antibiotic property.

### TECHNICAL FIELD

The present invention relates to a method for manufacturing a natural dye using beer sludge, and a dyeing method of a fiber product using a natural dye fabricated by the above method capable of extracting natural components from beer sludge that is a by-product after beer is manufactured.

### BACKGROUND ART

The source of beer is malt, yeast, hop, sub-sources of starch (starch, corn, rice, etc.). The malt that is a main source is generally used for brewing beer by germinating beer barley and drying the same. The components of barley are protein 10%, fat 0.5%, and starch 75. Namely, the starch is main component. The barley has more protein than rice and a large amount of necessary amino acids. Therefore, the barley is good for preventing aging of blood, beriberi, stomach, adult disease, etc. In addition, there are many fibrous components. In addition, vitamin, mineral, calcium, inorganic salts, etc. are uniformly included. Tannin component makes barley puckery.

So far, only a large size factory can fabricate beer. As the regulations of the Korean liquor law are amended, it is possible to fabricate beer at a small size factory, so that beer is directly served to customer at a restaurant. In the large size factory, the beer by-products are recycled as feed or fertilizer. However, in the small size factory, the beer by-products are discarded as wastes.

In the nature, it is possible to find some non-used plants that may be used for manufacturing natural dyes. It is needed to use the above non-used plants for manufacturing dyes, so that the wastes discarded may be recycled. In addition, it is possible to decrease time and efforts required for obtaining dyes.

As the materials used for the natural dyeing, there are skin of chestnut, outer skin of onion, outer skin of grape, etc. However, no study is performed to extract a certain dyeing component from the beer sludge and to use the same for dyeing fabrics.

### DISCLOSURE OF INVENTION

Accordingly, it is an object of the present invention to overcome the above-described problems.

It is another object of the present invention to recycle the wastes based on an environment policy.

It is further another object of the present invention to provide a method for manufacturing a natural dye using beer sludge, and a dyeing method of a fiber product using the natural dyes in such a manner that a coloring component is extracted from beer sludge that is easily collected, and the thusly extracted coloring components are used for dyeing fiber products.

To achieve the above objects, there is provided a method for manufacturing natural dyes using beer sludge, comprising the steps of a step for drying beer sludge, a step for mixing the dried beer sludge with a certain extraction solvent selected from the group comprising water, electrolysis reduction water, and electrolysis oxidation water, and extracting a coloring component, and a step for filtering an extraction liquid.

### BRIEF DESCRIPTION OF DRAWINGS

The present invention will become better understood with reference to the accompanying drawings which are given only by way of illustration and thus are not limitative of the present invention, wherein;

FIG. 1 is a picture of a result of an antibiotic test with respect to a blank fabric cloth; and

FIG. 2 is a picture of a result of an antibiotic test with respect to a fabric cloth according to the present invention.

### BEST MODE FOR CARRYING OUT THE INVENTION

The preferred embodiments of the present invention will be described with reference to the accompanying drawings.

In a method for manufacturing a natural dye using beer sludge, beer sludge is first dried, and the dried beer sludge is mixed with water, electrolysis, reduction water or electrolysis oxidation water, and then coloring components are extracted. At this time, the extraction process is performed at a water ratio of 1:5 through 10 at a temperature of 90˜100° C. for 2 through 3 hours.

After the extraction is performed, the extracts are filtered, and the filtered liquid may be directly used as dyes. The filtered liquids may be dried and manufactured as powder and then the powder may be used as dyes. At this time, the drying method is preferably a freezing and drying method. When the dyes are made in a form of powder, it is easy to store the dyes.

In order to check that what solvent is preferred when extracting coloring component from beer sludge, a test was performed using solvent in which distilled water of pH 6 and 7, electrolysis reduction water of 11 through pH 13, or electrolysis oxidation water of pH 3 and 4. At this time, the water ratio was 1:5, and the test was performed at 90∞100° C. for 180 minutes. The extracts were filtered and freeze-dried, and then the weight of the powders dyes was measured. In the freeze-drying process, a freezing and drying machine (Product model: Bondiro manufactured by the lishin corporation) was used. The extraction ratios (weight ratio of the powder dyes with respect to the weight of beer sludge) are shown in the following Table 1.

As seen therein, the dyes extracted using the electrolysis reduction water has the highest amount. In addition, it is known that the extraction ratio in an alkali condition is slightly larger than the extraction ratio in the distilled water. The electrolysis reduction water was fabricated using the electrolysis generator (Product model: J.A.W-020: NIPPON INTEK corporation).

TABLE 1

| Extraction solvent | Extraction ratio |
|---|---|
| Electrolysis reduction water | 13 through 15% |
| Distilled water | 12 through 14% |
| Electrolysis oxidation water | 9 through 11% |

The method for dyeing the fiber products using the natural dyes fabricated in the above-described method includes a step for adjusting pH of dyes, and a step for dipping fiber products into the pH-adjusted natural dyes.

At this time, the pH of the natural dyes is adjusted using nitric acid and sodium hydroxide. In order to check an effective dyeing of pH condition, woven fabric of cotton/nylon (hereinafter it is referred to C/N woven fabric) was dyed at a water ratio of 1:50 at a temperature of 90˜100° C. for 60 minutes with 3 through pH 9 using a computer color matching system (CCM), and then the K/S value was measured. A result of the test is shown in Table 2. As seen therein, the dyeing with a condition of pH 3 has the highest K/S value.

TABLE 2

| pH condition | K/S |
|---|---|
| pH 3 | 0.6732 |
| pH 4 | 0.5043 |
| pH 5 | 0.4748 |
| pH 6 | 0.4307 |
| pH 7 | 0.2544 |

A fiber product is dipped into the pH-adjusted natural dyes for thereby performing a dyeing operation. There are not any limits in the kinds of fabrics for dyeing. Namely, natural fiber products, chemical fiber products (synthetic fiber products, recycled fiber products, and semi-fiber products), etc. are dyed. In addition, the states of fiber products are not limited. Namely, thread, silk fabric, knitting fabric, clothes, etc. are possible.

The above dyeing operation is preferably performed at a water ratio of 1:40 through 60 at a temperature of 80 through 100° C. for 60 minutes.

In order to the dyeing property based on the repeated dyeing using the dyeing liquid extracted from beer sludge, the dyes were extracted using the electrolysis reduction water. The C/N woven fabric, knitted fabric and nylons were repeatedly dyed at a water ratio of 1:50 at a temperature of 90 througn 100° C. for 60 minutes. The K/S value was measured using the CCM with respect to the dyed products. A result of the same is shown in Table 3. As seen therein, the K/S value is the highest when it is dyed four times.

TABLE 4

| Number of dyeing | C/N woven fabric | Knitted fabric | Nylon fabric |
|---|---|---|---|
| 1 | 0.4863 | 0.2985 | 0.2696 |
| 2 | 0.6753 | 0.4548 | 0.5014 |
| 3 | 0.7526 | 0.6526 | 0.7544 |
| 4 | 0.8279 | 0.9037 | 0.9856 |

When using the natural dyes for dyeing, a previous mordanting method in which mordanting is performed before dyeing, a post mordanting method in which mordanting is performed after dyeing, and a concurrent mordanting method in which dyeing and mordanting are concurrently performed may be adapted.

As mordant used for the mordanting process, there are K₂Cr₂O₇, Kal(SO₄)₂.12H₂O, Al₂(SO₄)₃, CuSO₄, FeSO₄.7H₂O, SnCl₂.2H₂O. In addition, the addition amount of the mordant is 3 through 10% o.w.f.(on the weight of fiber), and the water ratio is 1:40 through 60, and a processing temperature and time is 80 through 100° C. and 30 through 60 minutes.

In order to check the dyeing property based on the effects of mordanting, the above-described six kinds of mordant were added based on 3 through 10% o.w.f., and the C/N woven fabric or knitting fabric was processed at a water ratio of 1:50 at a temperature of 80 through 100° C. for 60 minutes based on the previous mordanting method or the post mordanting method.

Table 4 shows the K/S value obtained as a result of the test that was performed in such a manner that the C/N woven fabric was previously mordanted, and then the K/S value was checked using the CCM with respect to the dyed fabrics. As seen therein, the K/S value is the highest when the mordanting concentration was 3% except for FeSO₄.7H₂O. When the concentration of the mordant was 10%, the K/S value is the lowest.

TABLE 4

| | Previous mordanting method | | |
|---|---|---|---|
| Mordant | K/S(3%) | K/S(5%) | K/S(10%) |
| K₂Cr₂O₇ | 0.442 | 0.438 | 0.156 |
| Kal(SO₄)₂.12H₂O | 0.373 | 0.286 | 0.147 |
| Al₂(SO₄)₃ | 0.369 | 0.229 | 0.139 |
| CuSO₄ | 0.447 | 0.316 | 0.146 |
| FeSO₄.7H₂O | 0.524 | 1.005 | 0.256 |
| SnCl₂.2H₂O | 0.497 | 0.391 | 0.239 |

The following Table 5 shows a result of the K/S values of the silk fabrics is dyed by the post mordanting method with respect to the C/N woven fabrics. In the post mordanting method, the K/S value is the highest of K₂Cr₂O₇ at 5%.

TABLE 5

| | Post mordanting method | | |
|---|---|---|---|
| Mordant | K/S(3%) | K/S(5%) | K/S(10%) |
| K₂Cr₂O₇ | 0.597 | 0.746 | 0.201 |
| Kal(SO₄)₂.12H₂O | 0.375 | 0.294 | 0.168 |
| Al₂(SO₄)₃ | 0.387 | 0.320 | 0.145 |
| CuSO₄ | 0.459 | 0.408 | 0.193 |
| FeSO₄.7H₂O | 0.650 | 0.536 | 0.450 |
| SnCl₂.2H₂O | 0.381 | 0.357 | 0.199 |

As seen in the Tables 4 through 5, the post mordanting method has a higher K/S value except for FeSO₄.7H₂O with respect to the C/N woven fabrics as compared to the previous mordanting method. In addition, as the concentration of the mordant is getting higher and higher, it is known that the dyeing property of the C/N woven fabrics is gradually decreased.

The following table 6 shows a result of the K/S values when the dyeing is performed with respect to the silk fabrics based on the previous mordanting method. At the concentration of the mordant, the K/S values of K₂Cr₂O₇, Kal(SO₄)₂.12H₂O, Al2(SO₄)₃ and CuSO₄ are the highest, and in the case of FeSO₄.7H₂O, when the concentration is 5%, the K/S value is the highest. In addition, in the case of SnCl₂.2H₂O, when the concentration is 10%, the K/S value is the highest.

TABLE 6

| | Previous mordanting method | | |
|---|---|---|---|
| Mordant | K/S(3%) | K/S(5%) | K/S(10%) |
| K₂Cr₂O₇ | 0.621 | 0.433 | 0.601 |
| Kal(SO₄)₂.12H₂O | 0.577 | 0.464 | 0.464 |
| Al₂(SO₄)₃ | 0.556 | 0.435 | 0.434 |
| CuSO₄ | 0.684 | 0.462 | 0.474 |
| FeSO₄.7H₂O | 0.775 | 0.856 | 0.807 |
| SnCl₂.2H₂O | 0.488 | 0.482 | 0.546 |

The following table 7 is a result of the test that the K/S values are measured with respect to the silk fabrics dyed by the post mandanting method. As seen therein, the K/S value of FeSO₄.7H₂O is the highest when the concentration of the mordant is 5%. In the post mordanting method, when the concentration is 5%, 10%, there is not much difference in the dyeing property, namely, similar dyeing properties are obtained.

TABLE 7

| | Post mordanting method | | |
|---|---|---|---|
| Mordant | K/S(3%) | K/S(5%) | K/S(10%) |
| K₂Cr₂O₇ | 0.448 | 0.556 | 0.652 |
| Kal(SO₄)₂.12H₂O | 0.313 | 0.486 | 0.452 |
| Al₂(SO₄)₃ | 0.297 | 0.498 | 0.506 |
| CuSO₄ | 0.656 | 0.785 | 0.763 |
| FeSO₄.7H₂O | 0.645 | 1.439 | 1.112 |
| SnCl₂.2H₂O | 0.353 | 0.518 | 0.482 |

As seen in Table 6 and 7, in the case that FeSO₄.7H₂O is used as the mordant, the K/S value is the highest when the concentration of the mordant is 5% in the post mordanting method. In addition, the K/S values are the highest when the concentration of the mordant is 3% in the previous mordanting method in the cases of the other five mordant.

The following table 8 is a result obtained by measuring the laundry fastness (KS K 0430) when six kinds of mordant are processed in the post mordanting method with respect to the C/N woven fabric and the silk fabric dyed using the dyeing liquid extracted from beer sludge. The non-mordanting woven fabric and the mordanting processed woven fabric have the high laundry fastness of 4 through 5 degrees.

TABLE 8

| Woven fabric | | |
|---|---|---|
| mordant | C/N woven fabric | Silk fabric |
| none | 4 through 5 | 4 through 5 |
| K₂Cr₂O₇ | 4 through 5 | 4 through 5 |
| Kal(SO₄)₂.12H₂O | 4 | 4 through 5 |
| Al₂(SO₄)₃ | 4 | 4 through 5 |
| CuSO₄ | 4 | 4 |
| FeSO₄.7H₂O | 4 | 4 through 5 |
| SnCl₂.2H₂O | 4 through 5 | 4 through 5 |

The evaluation of the antibiotic effects is conducted based on the KS K 0693-2001. The strain used was Staphylococcus aureus ATCC 6538. In addition, non-ion interface active agent (TWEEN 80) of 0.05% was used for the is inoculation bacillus. In the present invention, in order to evaluate the decrease ratio of bacillus of the woven fabric, the KS K 0905-1996 was used as the standard fabric.

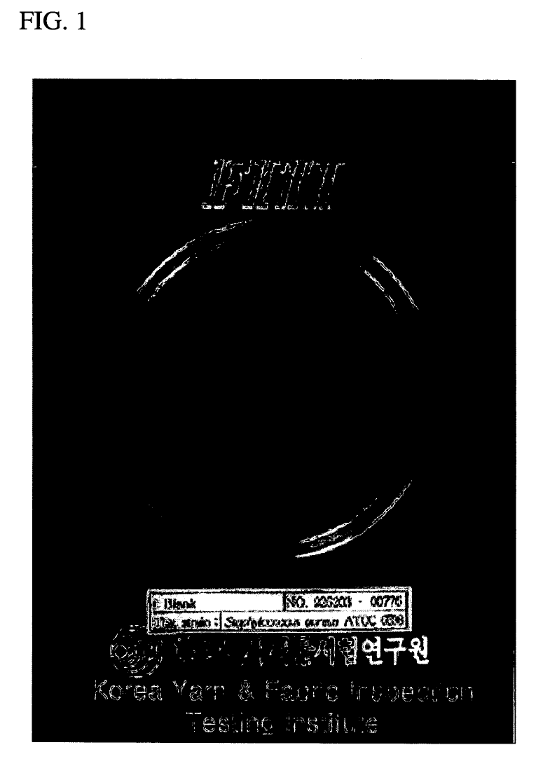

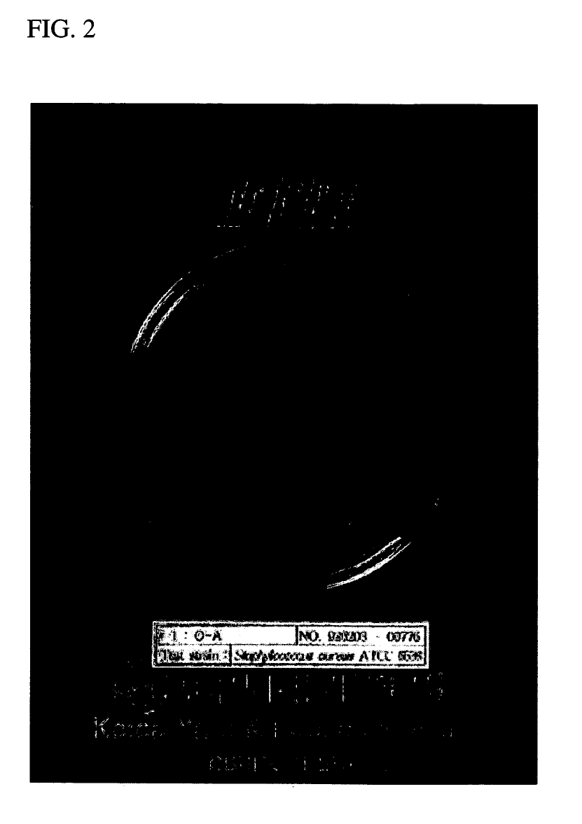

FIG. 1 is a picture of a blank state. As shown in FIG. 2, as a result of the experiment of the antibiotic property of the woven fabric dyed by the dyes extracted from beer sludge, the initial concentration with respect to the Staphylococcus aureus was 1.3×10⁵/ml, and the concentration after 18 hours was 1.2/10⁴/ml (5.9/10⁶/ml in the blank state), and the decrease ratio of the bacillus was 99.8%. Therefore, it is known that the effects are excellent.

Industrial Applicability

As described above, it is possible to achieve a desired recycling effect using wastes of beer sludge. The woven fabrics dyed using the dyes extracted from beer sludge may be widely adapted to various fiber products and has an excellent laundry fastness and excellent antibiotic property.

The present invention is not limited to the above embodiment. As the present invention may be embodied in several forms without departing from the spirit or essential characteristics thereof, it should also be understood that the above-described examples are not limited by any of the details of the foregoing description, unless otherwise specified, but rather should be construed broadly within its spirit and scope as defined in the appended claims, and therefore all changes and modifications that fall within the meets and bounds of the claims, or equivalences of such meets and bounds are therefore intended to be embraced by the appended claims.

1. A method for manufacturing natural dyes using beer sludge, comprising the steps of:
a step for drying beer sludge;
a step for mixing the dried beer sludge with a certain extraction solvent selected from the group comprising water, electrolysis reduction water, and electrolysis oxidation water, and extracting a coloring component; and
a step for filtering an extraction liquid.

2. The method of claim 1, wherein said extraction step has an extraction condition that the extraction is performed at a water ratio of 1:5 through 10 at a temperature of 90 through 100° C. for 2 through 3 hours.

3. The method of claim 1, after said filtering step, further comprising a step for drying the filtered liquid and then obtaining powder component.

4. The method of claim 3, wherein said drying step is achieved based on a freeze and drying process.

5. A natural dye using beer sludge fabricated based on a method comprising the steps of:
a step for drying beer sludge;
a step for mixing the dried beer sludge with a certain extraction solvent selected from the group comprising water, electrolysis reduction water, and electrolysis oxidation water, and extracting a coloring component; and
a step for filtering an extraction liquid.

6. A method for dyeing fiber product using a natural dye using beer sludge, comprising the steps of:
adjusting pH of a natural dye and
dipping a fiber product into the pH-adjusted natural dye and performing a dyeing process.

7. The method of claim 6, wherein pH of the natural dye is adjusted to 3 through 9 using nitric acid and sodium hydroxide, and said fiber product is one selected from the group comprising silk fabric, cotton fabric, nylon fabric and woven cotton/nylon, and the condition of said dyeing process is a water ratio of 1:40 through 60 at 80 through 100° C. for 60 minutes.

8. The method of claim 6, before the dyeing process, further comprising a step for performing a mordanting process.

9. The method of claim 6, after the dyeing process, further comprising a step for performing a mordanting process.

10. The method of claim 6, wherein said dyeing step and said mordanting step are concurrently performed.

11. The method of claim 10, wherein said mordanting step is performed using a mordant selected from the group comprising K₂Cr₂O₇, Kal(SO₄)₂.12H₂O, Al₂(SO₄)₃, CuSO₄, FeSO₄.7H₂O, and SnCl₂.2H₂O, and the adding amount of mordant is 3 through 10% o.w.t., and said mordanting step is performed at a water amount of 1:40 through 60 at a temperature of 80 through 100° C. for 60 minutes.

12. A fiber product dyed by a method for dyeing fiber product using a natural dye using beer sludge, comprising the steps of:
adjusting pH of a natural dye;
dipping a fiber product into the pH-adjusted natural dye and performing a dyeing process; and
performing a mordanting process.
